(19) United States
(12) Patent Application Publication
(10) Pub. No.: US 2001/0014562 A1
(43) Pub. Date: Aug. 16, 2001

(54) Crimp connector

(75) Inventors: Takao Murakami, Shizuoka (JP); Yoshitsugu Sawada, Shizuoka (JP)

Correspondence Address: ARMSTRONG,WESTERMAN, HATTORI,, MCLELAND & NAUGHTON, LLP, 1725 K STREET, NW, SUITE 1000, WASHINGTON, DC, 20006, US

(73) Assignee: Yazaki Corporation, Tokyo (JP)

(21) Appl. No.: 09/777,862

(22) Filed: Feb. 7, 2001

(30) Foreign Application Priority Data
Feb. 15, 2000 (JP) 2000-36101

(51) Int. Cl. H01R 4/10

(52) U.S. Cl. 439/877; 439/880

(57) ABSTRACT

A crimp connector 1 comprises a plurality of crimp terminals 23, and a housing 22 for containing the crimp terminals 23. Each of the crimp terminals 23 includes an electric wire crimping portion 31 and electric wire fixing portions 32, 32. The housing 22 includes partition walls 26, 26 uprightly provided on a base plate 25 to define groove-shaped terminal receiving chambers 24. The partition walls 26, 26 are provided with concave cut-out spaces 28, 28. The cut-out spaces 28, 28 are formed at positions facing with outer faces of the electric wire fixing portions 32, 32.

### BACKGROUND OF THE INVENTION

1. Field of the Invention

The present invention relates to a crimp connector comprising a plurality of crimp terminals and a housing for containing the crimp terminals.

2. Description of the Related Art

Heretofore, various types of crimp connectors for crimping and connecting covered wires have been known.

In FIG. 7, a conventional crimp connector 1 consists of a housing 3 in which a plurality of terminal receiving chambers 2 are arranged in parallel, and a plurality of crimp terminals 4 which are respectively contained in the terminal receiving chambers 2.

The terminal receiving chamber 2 is defined by a pair of partition walls 6, 6 which are uprightly provided on a base plate 5. A distance between the partition walls 6, 6 is so designed as to be almost equal to a width of the crimp terminal 4. A height of the partition wall 6 is so designed as to be lower than a height of the crimp terminal 4.

The crimp terminal 4 is contained in the terminal receiving chamber 2 with its electric wire guide-out end 8 positioned a slightly inside of a backward end 7 of the housing 3. Moreover, the crimp terminal 4 includes a box-like electrical contact portion provided at a forward end part of the housing 3. In rear of the electrical contact portion, is continuously provided a wire crimping portion 10 for crimping a covered electric wire 9.

The wire crimping portion 10 is provided with a pair of crimping pieces 11, 11 respectively having crimping slits for crimping the covered electric wire 9. In an area between the wire crimping portion 10 and the electric wire guide-out end 8, are formed a pair of electric wire fixing pieces 12, 12 which project in a tongue-like shape. By caulking the wire fixing pieces 12, 12 with a caulking punch 13 (see FIG. 8), the covered electric wire 9 is fixed.

In FIG. 8, the caulking punch 13 is provided at its lower end with a concave caulking portion 14 having a curved face so that a pair of the wire fixing portions 12, 12 are caulked inwardly along the curved face. The caulking portion 14 is formed wider than the crimp terminal 4. A depth d of the caulking portion 14 is formed relatively small, because the lower end of the caulking punch 13 is brought near upper end faces 15, 15 of the partition walls 6, 6 when the caulking punch 13 is moved in a direction of an arrow R to caulk the wire fixing portions 12, 12.

However, the above described prior art has had a problem that the wire fixing portions 12, 12 cannot be sufficiently caulked due to the shallow depth d of the caulking portion 14 of the caulking punch 13. For this reason, caulking condition of the wire fixing portions 12, 12 is not stabilized and there occur variations in their holding forces with respect to the covered wire 9.

Further, the wire fixing portions 12, 12 which have been caulked with the caulking punch 13 protrude upward above the upper end faces 15, 15 of the partition walls 6, 6 due to a shape of the caulking portion 14, and accordingly, a between-terminal leak is likely to occur between the wire fixing portions 12, 12 of the adjacent crimp terminals 4 interposing the partition wall 6.

The present invention has been made in view of the above described circumstances, and it is an object of the invention to provide a crimp connector in which the between-terminal leak can be prevented and the holding force for the covered wire will be stabilized.

### SUMMARY OF THE INVENTION

A crimp connector according to the present invention comprises a plurality of crimp terminals, and a housing for containing the crimp terminals, each of the crimp terminals including an electric wire crimping portion adapted to crimp a covered electric wire, and electric wire fixing portions positioned closer to an electric wire guide-out end than the electric wire crimping portion and adapted to caulk the covered electric wire, the housing including partition walls uprightly provided on a base plate to define groove-shaped terminal receiving chambers for receiving the crimp terminals, the terminal receiving chambers being arranged in parallel in a row in a number at least equal to the number of the crimp terminals, wherein the partition walls are provided with concave cut-out spaces for a caulking punch at positions facing with outer faces of the electric wire fixing portions.

According to another aspect of the present invention, the electric wire fixing portion is provided at only one side of the crimp terminal.

According to a further aspect of the present invention, the cut-out spaces are provided on respective middle parts of the partition walls in a longitudinal direction.

According to a still further aspect of the present invention, the cut-out spaces are formed including base ends of the partition walls which are continued to the base plate.

According to a still further aspect of the present invention, a height of the partition walls is at least higher than a height of the crimp terminals in a state after the electric wire fixing portions have been caulked.

According to the feature of the present invention, there is provided the crimp connector wherein the partition walls defining the terminal receiving chambers in the housing are formed with the concave cut-out spaces. Because the concave cut-out spaces are formed at the positions facing with the outer faces of the electric wire fixing portions, the caulking punch can be inserted deep below the upper end faces of the partition walls when the electric wire fixing portions are caulked. By thus inserting the caulking punch deep through the cut-out spaces, the electric wire fixing portions can be fully caulked. The holding force with respect to the covered electric wire will be stabilized and enhanced.

Since the cut-out spaces are concave with respect to the partition wall, the cut-out spaces of the adjacent terminal receiving chambers are not communicated with each other. Therefore, the between-terminal leak will not occur through the cut-out spaces.

According to a second aspect of the invention, one cut-out space is formed in the terminal receiving chamber. Accordingly, a thickness of the partition wall can be smaller than in the connector provided with a pair of the electric wire fixing portions on both sides of the crimp terminal. This enables a pitch of the crimp terminals contained in the terminal receiving chambers to be reduced.

According to a third aspect of the invention, the cut-out spaces are never formed in continuity with ends of the housing. Therefore, strength of the partition walls at the ends of the housing can be maintained.

According to a fourth aspect of the invention, the distal end of the caulking punch can be inserted deeply until it is brought near the base plate.

According to a fifth aspect of the invention, since the partition walls are higher than in the prior art, the between-terminal leak between the crimp terminals in the adjacent terminal receiving chambers can be reliably prevented.

### BRIEF DESCRIPTION OF THE DRAWINGS

FIG. 1 is a plan view of an essential part of a crimp connector according to one embodiment of the invention;

FIG. 2 is a sectional view taken along a line A-A of Fig.

FIG. 3 is a sectional view taken at a same position as FIG. 2 showing a state in which wire fixing portions have been caulked;

FIG. 4 is a plan view of an essential part of a crimp connector according to another embodiment of the invention;

FIG. 5 is a sectional view taken along a line B-B of FIG. 4;

FIG. 6 is a sectional view taken at a same position as FIG. 5 showing a state in which the wire fixing portions have been caulked;

FIG. 7 is a plan view of an essential part of a crimp connector in a conventional example; and

FIG. 8 is a sectional view taken along a line c-c of FIG.

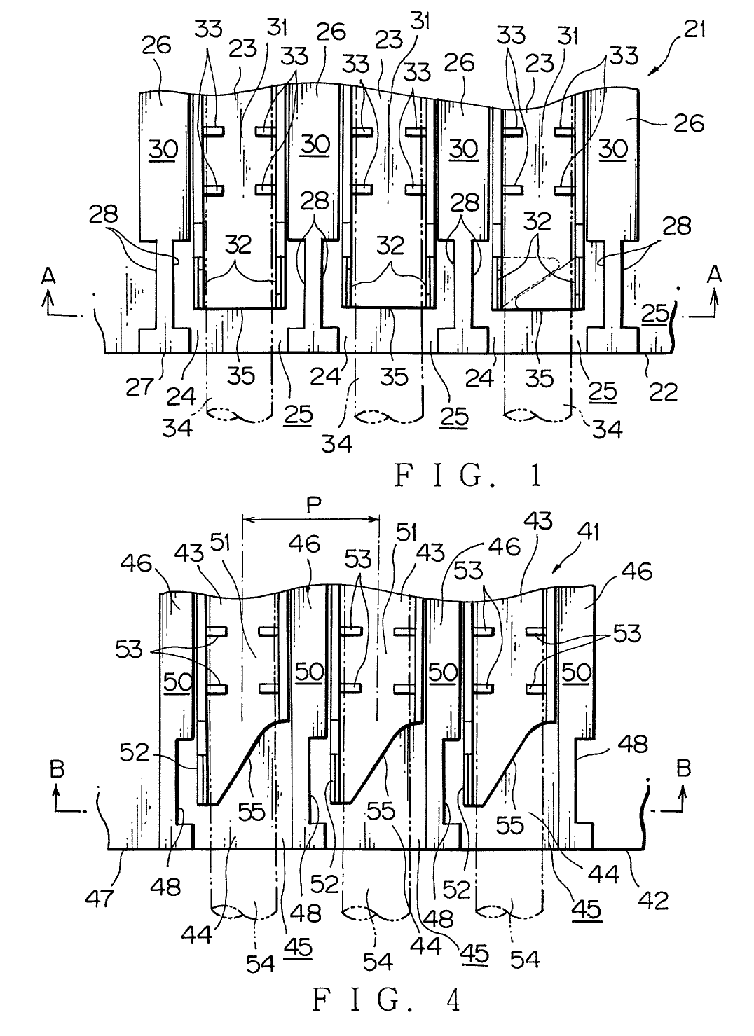

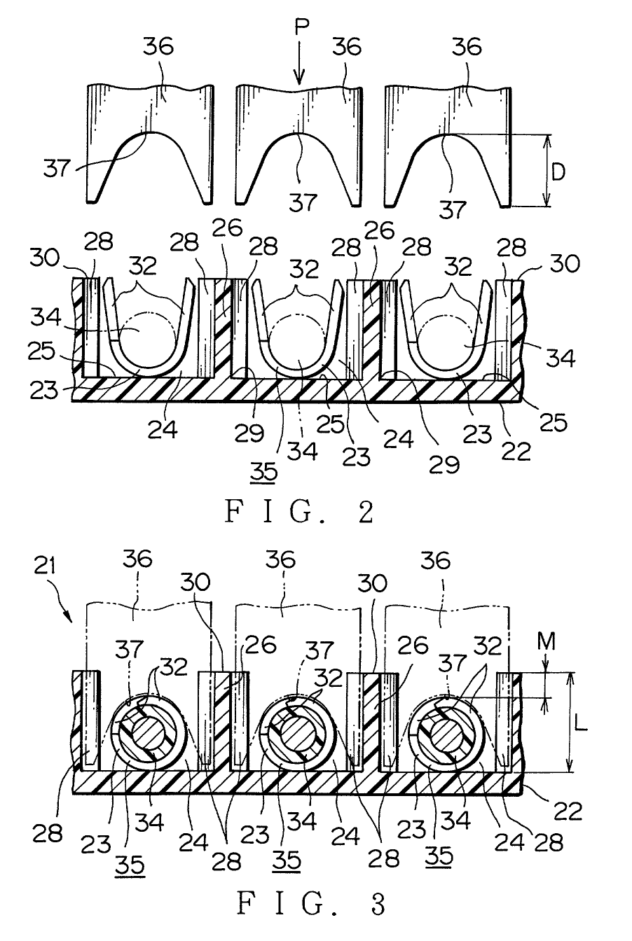

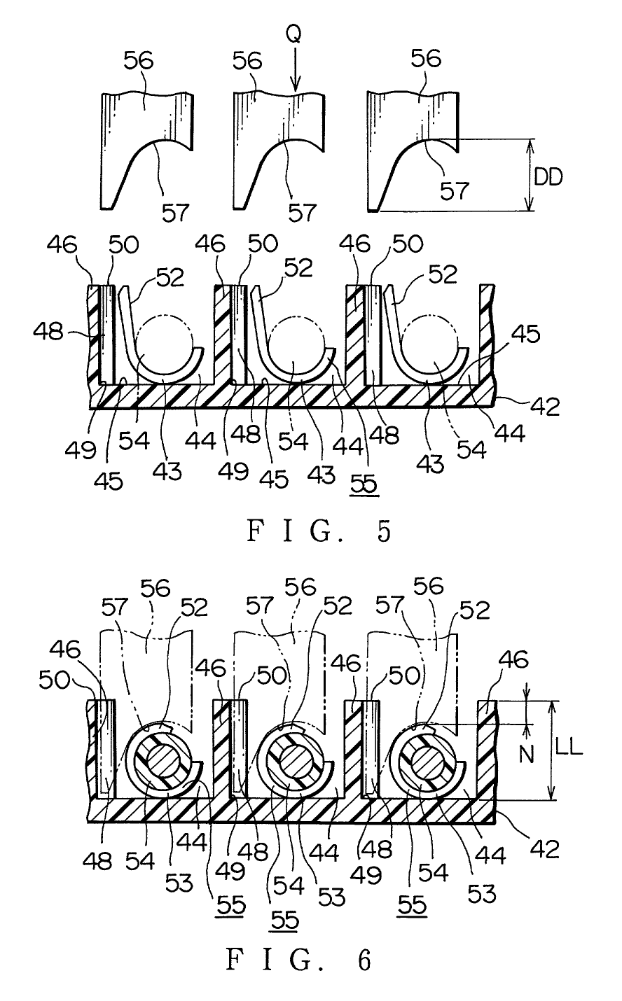

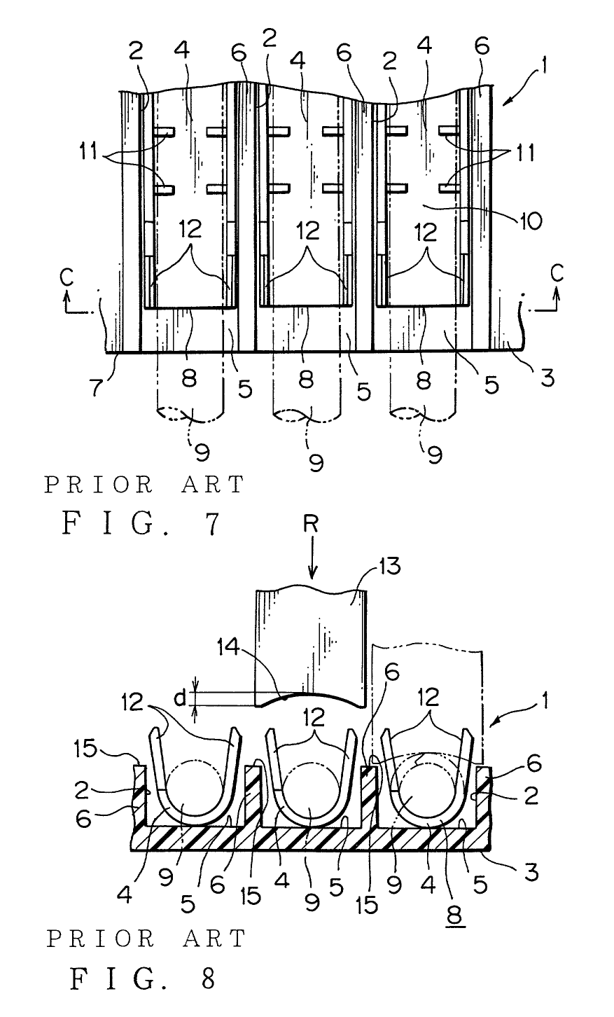

What is claimed is:

1. A crimp connector comprising;
a plurality of crimp terminals, and a housing for containing said crimp terminals,
each of said crimp terminals including an electric wire crimping portion adapted to crimp a covered electric wire, and electric wire fixing portions positioned closer to an electric wire guide-out end than said electric wire crimping portion and adapted to caulk said covered electric wire,
said housing including partition walls uprightly provided on a base plate to define groove-shaped terminal receiving chambers for receiving said crimp terminals, said terminal receiving chambers being arranged in parallel in a row in a number at least equal to the number of said crimp terminals,
wherein said partition walls are provided with concave cut-out spaces for a caulking punch at positions facing with outer faces of said electric wire fixing portions.

2. The crimp connector as claimed in claim 1, wherein said electric wire fixing portion is provided at only one side of said crimp terminal.

3. The crimp connector as claimed in claim 1, wherein said cut-out spaces are provided on respective middle parts of said partition walls in a longitudinal direction.

4. The crimp connector as claimed in claim 2, wherein said cut-out spaces are provided on respective middle parts of said partition walls in a longitudinal direction.

5. The crimp connector as claimed in claims 1, wherein said cut-out spaces are formed including base ends of said partition walls which are continued to said base plate.

6. The crimp connector as claimed in claims 2, wherein said cut-out spaces are formed including base ends of said partition walls which are continued to said base plate.

7. The crimp connector as claimed in claims 3, wherein said cut-out spaces are formed including base ends of said partition walls which are continued to said base plate.

8. The crimp connector as claimed in claims 4, wherein said cut-out spaces are formed including base ends of said partition walls which are continued to said base plate.

9. The crimp connector as claimed in any one of claims 1 to 8, wherein a height of said partition walls is at least higher than a height of said crimp terminals after said electric wire fixing portions have been caulked.
